(19) United States
(12) Patent Application Publication
(10) Pub. No.: US 2007/0022222 A1
(43) Pub. Date: Jan. 25, 2007

(54) Memory device and associated method

(76) Inventors: Tsung Hsien Wu, Taipei City (TW); Wei Lun Hsu, Taipei City (TW); Wen Chih Chiu, Taipei City (TW); Feng Hsi Lin, Taipei City (TW)

Correspondence Address: Raymond Sun, 12420 Woodhall Way, Tustin, CA, 92782, US

(21) Appl. No.: 11/489,430

(22) Filed: Jul. 18, 2006

(30) Foreign Application Priority Data
Jul. 20, 2005 (TW) 094124442
Jan. 2, 2006 (TW) 095110488

(51) Int. Cl. G06F 3/00

(52) U.S. Cl. 710/13

(57) ABSTRACT

A memory device and an associated operating method are provided to implement a customized function of the memory device by using a specially designed command packet. In one embodiment, a manufacture reserved command defined by a standard protocol is used and a corresponding customized command argument is configured, so as to generate a customized command packet compatible with the standard protocol. In another embodiment, an access command defined by the standard protocol is used and an access address, which is either an illegal address or an address lying outside an addressing range of the user area of the memory device, is configured in a corresponding command argument, so as to generate an access command packet. The memory device can perform the customized function according to the customized command packet or the access command packet mention above.

### BACKGROUND OF INVENTION

1. Field of the Invention

The present invention relates to a memory device, and more particularly to a memory device and an associated operating method which can use a specially designed command packet to implement a customized function of the memory device.

2. Description of the Prior Art

Along with the rapid advancement of informaiton technology, demands for information grow explosively. The availability and prevalence of small portable memory devices in recent years, e.g. the flash memory-based USB flash disk (commonly referred to as “silicon disk drive” or “thumb drive”) and memory cards, e.g. CF (compact flash), MS (memory stick), SD Card (Secure Digital card), MMC (MultiMedia card), and xD, and micro hard disk with CF or USB interface, or the external USB or PCMCIA interfaced 2.5-inch hard disk, have more or less satisified our increasing longing for “information portability”.

Currently available portable memory devices ordinarily comprise a non-volatile memory array, a controller, and a transmission interface (I/O Interface). The memory array is used for storing data and must be capable of preserving the stored data without external power supply. Thus memory array typically consists of flash memory or a hard disk. The controller comprises circuits, interfaces and driving mechanism for driving and accessing the memory array. The driving mechanism may be provided as a hardware in the form of a command sequencer circuit for executing a series of micro-code programs, or in the form of a micro-controller/micro-processor circuit disposed in the controller of the portable memory device for executing a series of firmware programs. The transmission interface will determine a communication protocol by which the portable memory device can link and communicate with an external device.

FIG. 1 is a diagram showing the area arrangement of a flash memory array 10 in a conventional portable memory device. As shown, the flash memory array 10 includes a system area 11, a user area 12, and a protected area 13. The system area 11 stores a firmware and associated data required for the controller of the memory device. The user area 12 can be directly accessed by a user via an external device coupled to the memory device. The protected area 13 stores the data generated by an encryption protocol supported by the memory device. A user cannot directly access the protected area 13, and data protection is thus assured. For example, the SD card supports CPRM (Content Protection for Recordable Media) standard for the protected area 13.

FIG. 2 is a diagram showing a bus included in the transmission interface of the conventional portable memory device. The bus can function as a command (CMD) bus or a data (DAT) bus. The CMS bus is used to transmit command packets 20 and response packets 30. The command packet 20 contains a command issued by the external device to the memory device. The response packet 30, issued by the memory device, contains a reply to the previous command packet 20. The DAT bus is used to transmit data packets 40, which contain the data that the external device writes in or reads from the memory device.

The conventional portable memory device reads from or writes into the user area 12 or the protected area 13 according to the command packet 20. FIG. 3 shows a format of the command packet 20, which includes fields of start bit 21, transmitter bit 22, command index 23, command argument 25, cyclic redundancy check (CRC) 27, and end bit 28. The starting bit 21, transmission bit 22, and ending bit 28 are used for identifying a signal transmission. The command index 23 designates a command issued by the external device, e.g. read, write, status inquiry, etc. The command argument 25 is required for executing the command designated in the command index 23. CRC 27 is used for detecting and correcting transmission errors.

FIGS. 4A and 4B show the formats of a read command packet and a write command packet respectively. These packet formats are defined in the communication protocol support by the memory device, and only the major differences between them are shown. In FIG. 4A, the command index 23 is a read command defined in the communication protocol, and the command argument 25 is a read address designated by the read command. For example, in the SD card, the command index 23 for the read command is CMD 17 or CMD 18, and the command argument 25 is a 32-bit read address. In FIG. 4B, the command index 23 is a write command defined in the communication protocol, and the command argument 25 is a write address designated by the write command. For example, in the SD card, the command index 23 for the write command is CMD 24 or CMD 25, and the command argument 25 is a 32-bit write address.

Please refer to FIG. 1 again. By using the read/write command packet shown in FIG. 4A/4B, the external device can easily access the user area 12. Thus, the user data stored in the user area 12 cannot be prevented from deleting or copying, i.e. no data protection is provided in the user area 12. On the other hand, though the protected area 13 can provide data protection, a lot of complicated data processing is needed to achieve that. For instance, to implement CPRM standard in the SD card, a lot of data encryption and decryption is performed. This would bring a heavy load for the portable memory device.

Moreover, since the user demand for the portable memory device is increasingly various, the manufacturer needs to provide a portable memory device with various customized functions in a manner compatible with a standard communication protocol such as CF, SD, MS, MMC, etc.

### SUMMARY OF INVENTION

It is therefore one objective of the present invention to provide a memory device and an associated operating method which can use a specially designed command packet to implement a customized function of the memory device.

According to one embodiment of this invention, a memory device supporting a communication protocol is provided. The memory device comprises a non-volatile memory, a transmission interface and a controller. The transmission interface is for receiving a customized command packet compatible with the communication protocol, where the customized command packet comprises a manufacture reserved command defined in the communication protocol and a customized command argument. The controller, coupled to the transmission interface and the non-volatile memory, is for performing a customized function corresponding to the customized command argument.

According to another embodiment of this invention, a memory device supporting a communication protocol is provided. The memory device comprises a non-volatile memory, a transmission interface and a controller. The non-volatile memory includes a user area. The transmission interface is for receiving an access command packet, which is defined in the communication protocol and includes an access command defined in the communication protocol. The access command designates an access address which is an illegal address or does not belong to an addressing range of the user area. The controller, coupled to the transmission interface and the non-volatile memory, is for performing a corresponding customized function according to the access command packet.

According to another embodiment of this invention, a method for operating a memory device is provided. The memory device supports a communication protocol and includes a user area. The method comprises steps of: receiving an access command packet comprising an access command defined in the communication protocol; and

performing a corresponding customized function of the memory device if the access command designates an access address which is an illegal address or does not belong to an addressing range of the user area.

### BRIEF DESCRIPTION OF THE DRAWINGS

The details of the present invention will be more readily understood from a detailed description of the preferred embodiments taken in conjunction with the following figures.

FIG. 1 is a diagram showing the area arrangement of a flash memory array in a conventional portable memory device.

FIG. 2 is a diagram showing a bus included in the transmission interface of the conventional portable memory device.

FIG. 3 is a diagram showing a format of the command packet in FIG. 2.

FIGS. 4A and 4B are diagrams showing the formats of a read command packet and a write command packet respectively.

FIG. 5 is a block diagram of a preferred embodiment of the memory device according to the present invention.

FIG. 5A is a diagram showing an arrangement embodiment of the customized area in FIG. 5.

FIG. 6 is a block diagram of a verifying command packet according to a first embodiment of the accessing method for the memory device in FIG. 5.

FIG. 7 is a flow chart of the first embodiment of an accessing method for the memory device in FIG. 5.

FIG. 8 is a block diagram of a verifying command packet according to a second embodiment of the accessing method for the memory device in FIG. 5.

FIG. 9 is a flow chart of the second embodiment of the accessing method for the memory device in FIG. 5.

FIG. 10A is a block diagram of a verifying command packet according to a third embodiment of the accessing method for the memory device in FIG. 5.

FIG. 10B is a block diagram of a read command packet issued after the verifying command packet of FIG. 10A according to the third embodiment of the accessing method for the memory device in FIG. 5.

FIG. 11 is a flow chart of the third embodiment of the accessing method for the memory device in FIG. 5.

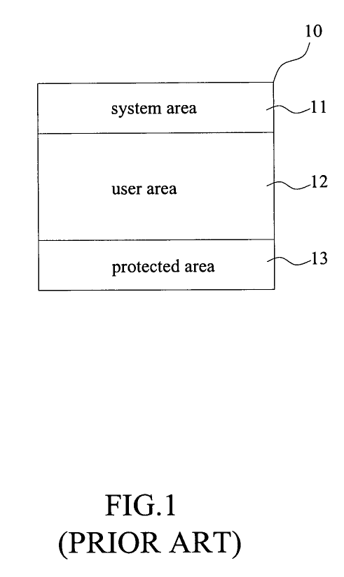

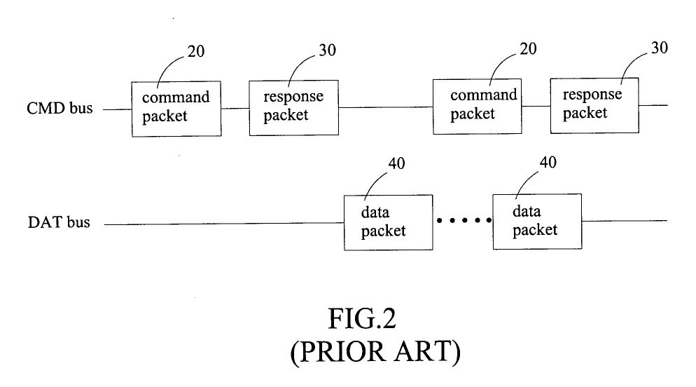

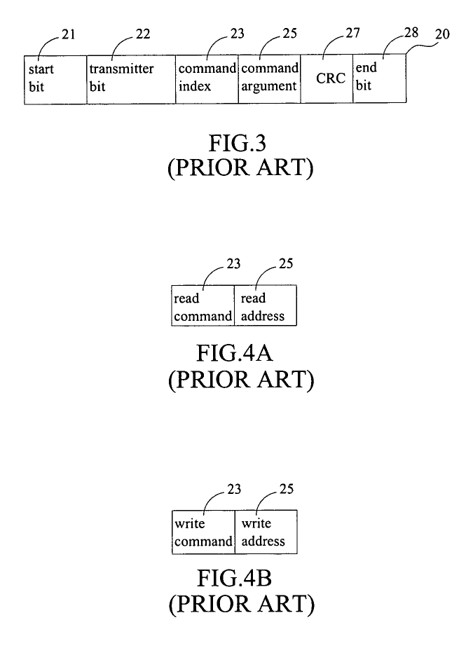

### DETAILED DESCRIPTION

According to one embodiment of the memory device and the associated operating method of this invention, a customized command packet compatible with a communication protocol supported by the memory device is used to instruct the memory device to perform a corresponding customized function, e.g. accessing a customized area within the memory device, as described later. The customized command packet includes a manufacture reserved command and a customized command argument. The manufacture reserved command is defined in the communication protocol and reserved for flexible use by a manufacturer. When receiving the customized command packet, the memory device determines whether to perform the corresponding customized function according to whether the customized command argument contains a specific customer identification code.

According to another embodiment of the memory device and the associated operating method of this invention, an access command packet defined in a communication protocol supported by the memory device is used to instruct the memory device to perform a corresponding customized function. The access command packet includes an access command, and a corresponding command argument which is an address field for storing a designated access address. In this specification, the access command packet is either a write command packet (i.e. the access command is a write command) or a read command packet (i.e. the access command is a write command), as shown in FIGS. 4A and 4B. The designated access address can be an illegal address or an address lying outside (i.e. larger or smaller than) the addressing range of a user area within the memory device. For instance, an address larger than the addressing range of the user area can be easily formed by putting any address within the addressing range into the address field and then setting the most significant bit (MSB) of the address field as 1. Besides, when the access command is a write command, the memory device determines whether to perform the customized function according to whether a write data packet associated with the write command contains a specific customer identification code.

In still another embodiment of this invention, the customized function mentioned above is to access a customized area within the memory device. Since whether the accessing to the customized area is performed is determined by means of a specially designed command packet (i.e. the customized command packet or the access command packet with a specific designated access address as described above), data stored in the customized area can be protected from being copied or deleted by an unauthorized user. Thus, any protection-requiring data, such as pre-recorded application data, verifying information of application programs, usage logs of users or devices, etc., can be stored into the customized area. Furthermore, in this embodiment, since the customized area of the memory device can store the result of a verification or authorization procedure for an application program, a user can connect the memory device to any compatible cross-platform external device to execute the application program without need to repeatedly perform the verification or authorization procedure.

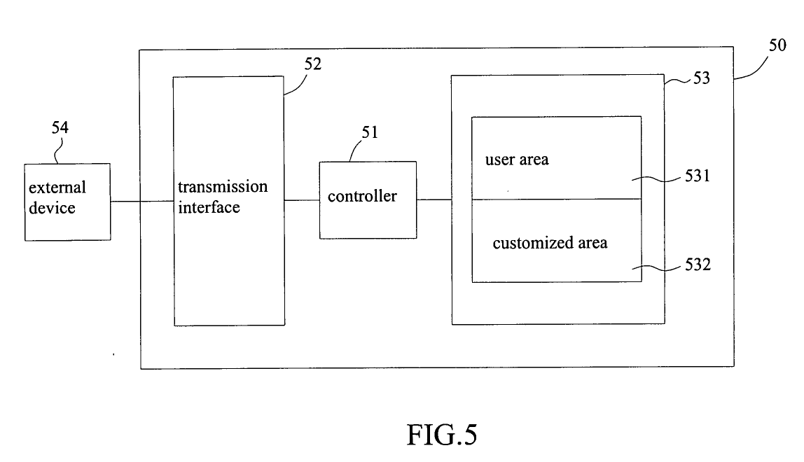

FIG. 5 is a block diagram of a preferred embodiment of the memory device according to the present invention. In this preferred embodiment, the memory device 50 supports a communication protocol and comprises a controller 51, a transmission interface 52, and a non-volatile memory 53 including a user area 531 and a customized area 532. The transmission interface 52 receives from a coupled external device 54 a verifying command packet compatible with the communication protocol. The controller 51 is coupled to the transmission interface 52 and the non-volatile memory 53, and determines whether the external device 54 can access the customized area 532 according to the verifying command packet. Besides, the transmission interface also receives from the external device 54 an access command packet, which is defined in the communication protocol and designates an access address within the user area 531. The controller 51 directly accesses the user area 531 according to the access command packet. In this preferred embodiment, the memory device 50 can be a portable device, and the communication protocol can be USB, CF, MS, MMC, or SD. Also, the non-volatile memory 53 is a flash memory or hard disk.

FIG. 5A is a diagram showing an arrangement embodiment of the customized area 532. As shown, the customized area 532 includes a read-only sub-area 5321, a rewritable sub-area 5322, and a write-once sub-area 5323. Though the non-volatile memory 53 is rewritable itself, an equivalent read-only or write-once function can be achieved with the cooperation of the controller 51. The read-only sub-area 5321 is written only during the manufacturing process of the memory device 50, so as to prevent the data therein from malicious alteration. In addition, an application program may store its use history, e.g. the date when the program is first used, in the write-once sub-area 5323. The rewritable sub-area 5322 can store program files or data files of an application program, and keep these files from being copied or deleted by a user.

According to a first embodiment of an accessing method for the memory device 50, a verifying command packet 201, which contains a manufacture reserved command and a specific verifying information, is issued by the external device 54 to the memory device 50 to make an area switch first. That is, the area to be accessed is changed from the user area 531 to the customized area 532. Then, the external device 54 issues a subsequent access command to address the customized area 532.

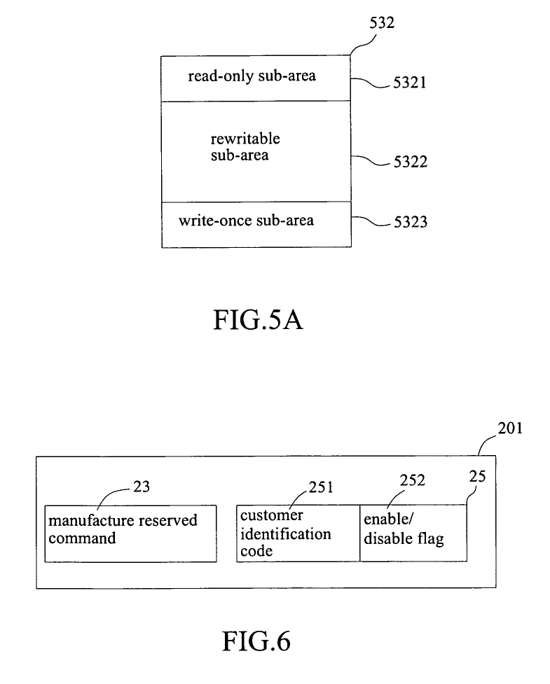

FIG. 6 is a block diagram of the verifying command packet 201 according to the first embodiment of the accessing method for the memory device 50. As shown, in the verifying command packet 201, the command index 23 is a manufacture reserved command and the command argument 25 includes a customer identification code 251 and an enable/disable flag 252. The customer identification code 251 is used to verify whether the external device 54 or a specific application program executed thereon can access the customized area 532. The enable/disable flag 252 is used to enable or disable the accessing to the customized area 532. For instance, when the enable/disable flag 252 is 1 (0), the accessing to the customized area 532 is enabled (disabled).

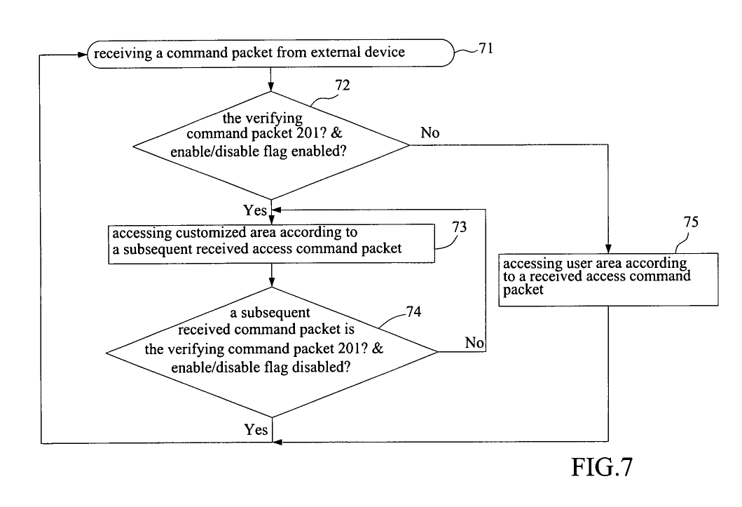

FIG. 7 is a flow chart of the first embodiment of the accessing method for the memory device 50. As shown, this flow includes:

Step 71: the memory device 50 receiving a command packet from the external device 54.

Step 72: determining whether the received command packet is the verifying command packet 201 and the enable/disable flag is enabled. If yes then execute Step 73; otherwise, execute Step 75.

Step 73: accessing the customized area 532 according to a subsequent received access command packet designating an access address within the customized area 532.

Step 74: determining whether a subsequent received command packet is the verifying command packet 201 and the enable/disable flag is disabled. If yes then execute Step 71; otherwise, execute Step 73.

Step 75: accessing the user area 531 according to a received access command packet and returning to Step 71.

According to a second embodiment of the accessing method for the memory device 50, a verifying command packet 202, which contains a manufacture reserved command and a specific command argument, is issued by the external device 54 for accessing to the customized area 532 of the memory device 50. The specific command argument is configured as described later such that both the verification and access are executed in a single command packet. Thus, both the customized area 532 and the user area 531 are simultaneously available for being accessed by the external device 54. That is, if the customized area 532 is to be accessed, the external device 54 issues the verifying command packet 202 to the memory device; if the user area 532 is to be accessed, the external device 54 issues an access command packet designating an access address within the user area 532.

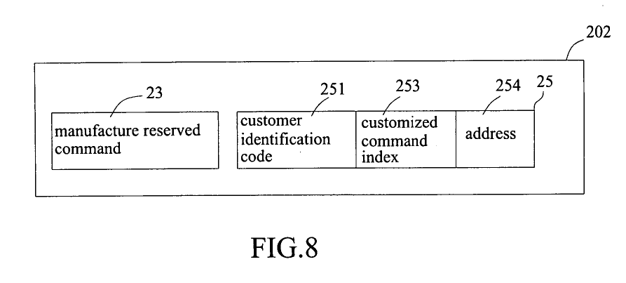

FIG. 8 is a block diagram of the verifying command packet 202 according to the second embodiment of the accessing method for the memory device 50. As shown, in the verifying command packet 202, the command index 23 is a manufacture reserved command and the command argument 25 includes the customer identification code 251, a customized command index 253 and an address 254. When the command index 23 is the manufacture reserved command, it means a command acting on the customized area 532. The customized command index 253 indicates the command type (e.g. read or write) acting on the customized area 532. The address 254 is an address associated with the customized command index 253.

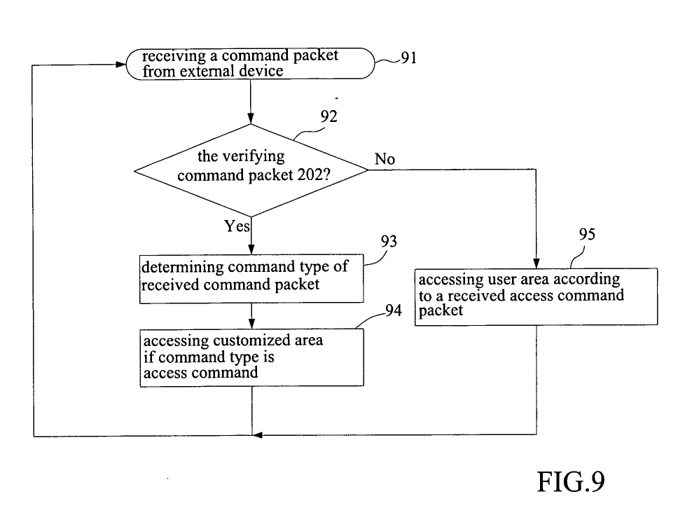

FIG. 9 is a flow chart of the second embodiment of the accessing method for the memory device 50. As shown, this flow includes:

Step 91: the memory device 50 receiving a command packet from the external device 54.

Step 92: determining whether the received command packet is the verifying command packet 202. If yes then execute Step 93; otherwise, execute Step 95.

Step 93: determining the command type of the received command packet according to the customized command index 253.

Step 94: accessing the customized area 532 if the customized command index 253 is determined as an access command and returning to Step 91, wherein the address to be accessed is the address 254.

Step 95: accessing the user area 531 according to a received access command packet and returning to Step 91.

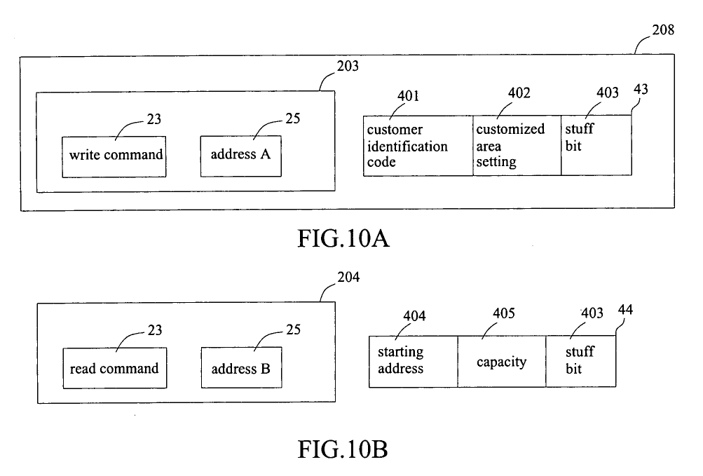

FIG. 10A is a block diagram of the verifying command packet 208 according to a third embodiment of the accessing method for the memory device 50. As shown, the verifying command packet 208 contains a write command packet 203 defined in the communication protocol and an associated data packet 43. In the write command packet 203, the command index 23 is a write command and the command argument 25 is a write address A, which is a specific address not belonging to address ranges of the user area 531 and the customized area 532. The data packet 43 includes a customer identification code 401, a customized area setting 402, and stuff bits 403. The customized area setting 402 includes setting parameters associated with the customized area 532. The stuff bits 403 are used to enlarge the data packet 43 to a specific size, so as to meet the communication protocol of the memory device 50. By issuing the verifying command packet 208, the external device 54 provides verification information (i.e. the customer identification code 401) to the controller 51 for determining whether the external device 54 or a specific application program executed thereon can access the customized area 532.

In the third embodiment, after issuing the verifying command packet 208, the external device 54 issues a read command packet 204 defined in the communication protocol, as shown in FIG. 10B. In the read command packet 204, the command index 23 is a read command, and the command argument 25 is a read address B, which is similar to the write address A and also not belonging to the address ranges of the user area 531 and the customized area 532. When receiving the read command packet 204, the controller 51 would reply a data packet 44 to the external device 54. The data packet 44 includes a starting address 404 of the customized area 532, a capacity 405 of the customized area 532, and stuff bits 403. The starting address 404 provides an offset required for addressing the customized area 532. By combing the starting address 404 and the capacity 405, the external device 54 can define the addressing range of the customized area 532 as from the starting address 404 to the starting address 404 plus the capacity 405, and then access the customized area 532 by issuing an access command packet with a designated access address lying within the addressing range of the customized area 532. Since the third embodiment utilizes the access command (i.e. the write command packet 203 and read command packet 204) of the original communication protocol to access the customized area 532, the third embodiment can be easily implemented in the existing application programs executed on the external device 54, without the compatibility issue.

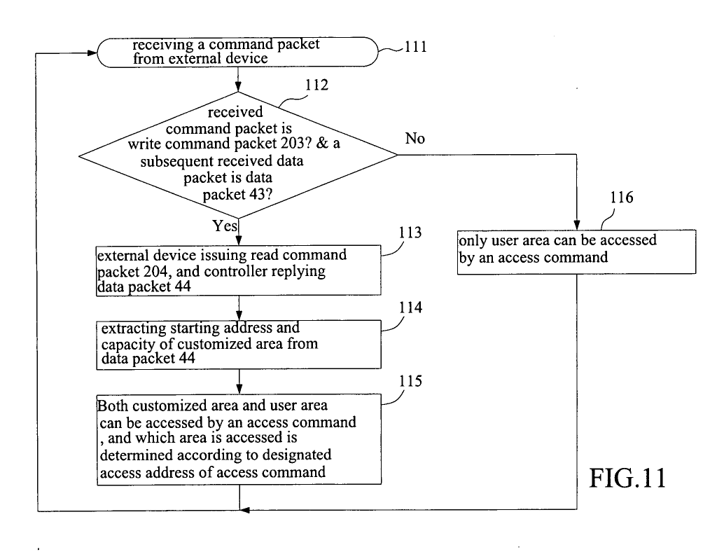

FIG. 11 is a flow chart of the third embodiment of the accessing method for the memory device 50. As shown, this flow includes:

Step 111: the memory device 50 receiving a command packet from the external device 54.

Step 112: determining whether the received command packet is the write command packet 203 and a subsequent received data packet is the data packet 43. If yes then execute Step 113; otherwise, execute Step 116.

When a conventional memory device receives the write command packet 203, it would issue a response packet to indicate that an erroneous or illegal command is received. However, when the memory device 50 of the present invention receives the write command packet 203, it would reply that a legal command is received. Thus, the external device 54 can determine whether a coupled memory device supports the verification of the accessing to a customized area of the present invention.

Step 113: the external device 54 issuing the read command packet 204, and the controller 51 replying the data packet 44.

Step 114: extracting the starting address 404 and the capacity 405 of the customized area 532 from the data packet 44.

Step 115: the verification of the accessing to the customized area 532 is completed. Both the customized area 532 and the user area 531 can be accessed by an access command defined in the communication protocol, and which area is to be accessed is determined according to the designated access address of the access command.

Step 116: the verification of the accessing to the customized area 532 is not completed. Only the user area 531 can be accessed by an access command.

In the third embodiment, the write address A and read address B can also be illegal addresses. For instance, in SD specification, an address is a multiple of 512 bytes. Thus, the write address A and read address B can be addresses not multiples of 512 bytes and even lying within the addressing range of the user area 531. An example for the write address A and read address B is an address lying within the addressing range of the user area 531, and the least significant bit (LSB) of the address is 1.

In one embodiment, the access address for the customized area 532 (or the user area 531) in the above first, second, and third embodiments is generated according to a relative address within the customized area 532 (or the user area 531) and an area code of the customized area 532 (or the user area 531). For example, if the capacity of the customized area 532 is 128 M bytes, then the range of the relative address is 0˜(128M−1)(assuming that each relative address represents one byte memory space). The area code is used to distinguish the customized area 532 from the user area 531. For instance, the area codes of the user area 531 and the customized area 532 can be respectively set as a binary 0 and 1. In a preferred embodiment, the access address for the user area 531 or the customized area 532 is generated by directly combining the area code and the relative address. For instance, the area code and relative address can be respectively put into the higher and lower bits of the corresponding address field of the access command (or the verifying command packet 202 of the second embodiment).

In another embodiment, the access address for the customized area 532 in the first, second, and third embodiments is generated according to a relative address within the customized area 532 and an address offset. The magnitude of the address offset is selected such that the addressing range of the customized area 532 does not overlap with that of the user area 531. For example, if the capacities of the user area 531 and the customized area 532 are 128M and 256 M bytes respectively and each relative address represents one byte memory space, then the addressing ranges of 0˜(128M−1) and 128M˜(128M+256M−1) can be respectively used for the user area 531 and the customized area 532. That is, the address offset is selected as 128M such that the addressing ranges of both the user area 531 and the customized area 532 do not overlap.

Since the manner for accessing the customized area 532 is defined by the controller 51 and not changed by the user operation or an application program executed on the external device 54, the present invention can provide a more reliable data protection.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A memory device supporting a communication protocol comprising:
a non-volatile memory;
a transmission interface for receiving a customized command packet compatible with the communication protocol, wherein the customized command packet comprises a manufacture reserved command defined in the communication protocol and a customized command argument; and
a controller, coupled to the transmission interface and the non-volatile memory, for performing a customized function corresponding to the customized command argument.

2. The memory device of claim 1, wherein the controller determines whether to perform the customized function according to whether the customized command argument comprises a specific customer identification code.

3. The memory device of claim 2, wherein the customized command packet is issued by an external device, and the non-volatile memory comprises a customized area, wherein the controller determines whether to allow the external device to access the customized area according to whether the customized command argument comprises the specific customer identification code.

4. The memory device of claim 3, wherein if the customized command argument comprises the specific customer identification code and an enable/disable flag, the controller determines to enable or disable the external device to access the customized area according to the enable/disable flag.

5. The memory device of claim 4, wherein the external device issues an access command packet defined in the communication protocol to access the customized area, wherein the access command packet corresponds to an access address of the customized area.

6. The memory device of claim 3, wherein if the customized command argument comprises the specific customer identification code, a customized command index, and an access address of the customized area, the controller accesses the customized area according to the customized command index and the access address.

7. The memory device of claim 5, wherein the non-volatile memory further comprises a user area, and the access address is generated according to a relative address within the customized area and an address offset, a magnitude of which is selected such that an addressing range of the customized area does not overlap with that of the user area.

8. The memory device of claim 6, wherein the non-volatile memory further comprises a user area, and the access address is generated according to a relative address within the customized area and an address offset, a magnitude of which is selected such that an addressing range of the customized area does not overlap with that of the user area.

9. The memory device of claim 5, wherein the access address is generated according to a relative address within the customized area and an area code of the customized area.

10. The memory device of claim 6, wherein the access address is generated according to a relative address within the customized area and an area code of the customized area.

11. A memory device supporting a communication protocol comprising:
a non-volatile memory comprising a user area;
a transmission interface for receiving an access command packet defined in the communication protocol, wherein the access command packet comprises an access command defined in the communication protocol, and the access command corresponds to an access address which is one of an illegal address and an address not belonging to an addressing range of the user area; and
a controller, coupled to the transmission interface and the non-volatile memory, for performing a corresponding customized function according to the access command packet.

12. The memory device of claim 11, wherein the access command is a write command, and the controller determines whether to perform the customized function according to whether a corresponding write data packet of the access command packet comprises a specific customer identification code.

13. The memory device of claim 12, wherein the access command packet and the corresponding write data packet are issued by an external device, and the non-volatile memory further comprises a customized area, wherein the controller determines whether to allow the external device to access the customized area according to whether the corresponding write data packet comprises the specific customer identification code.

14. The memory device of claim 13, wherein the external device issues a read command packet defined in the communication protocol to the memory device to obtain a starting address and a capacity of the customized area, wherein the read command packet corresponds to a read address which is one of an illegal address and an address not belonging to the addressing range of the user area.

15. The memory device of claim 13, wherein the external device issues an access command packet to access the customized area, wherein the access command packet corresponds to an access address of the customized area.

16. The memory device of claim 15, wherein the access address is generated according to a relative address within the customized area and an area code of the customized area.

17. The memory device of claim 16, wherein the access address is generated according to a relative address within the customized area and an address offset, a magnitude of which is selected such that an addressing range of the customized area does not overlap with that of the user area.

18. A method for operating a memory device supporting a communication protocol and comprising a user area, the method comprising steps of:
receiving an access command packet comprising an access command defined in the communication protocol; and
performing a corresponding customized function of the memory device if the access command corresponds to an access address which is one of an illegal address and an address not belonging to an addressing range of the user area.

19. The method of claim 18, wherein the access command is a write command, and the method further comprises:
receiving a corresponding write data packet of the write command;
wherein the customized function is performed when the corresponding write data packet comprises a specific customer identification code.

20. The method of claim 19, further comprises:
returning an error message if the corresponding write data packet does not comprise the specific customer identification code.

21. The method of claim 19, wherein the access command packet is issued by an external device, and the memory device further comprises a customized area, wherein the external device is allowed to access the customized area when the corresponding write data packet comprises the specific customer identification code.
